(19) United States
(12) Patent Application Publication
(10) Pub. No.: US 2001/0038999 A1
(43) Pub. Date: Nov. 8, 2001

(54) System and method for drawing electronic images

(76) Inventor: Robert Owen Hainey II, Neshanic Station, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/776,488

(22) Filed: Feb. 2, 2001

Related U.S. Application Data
(60) Provisional application No. 60/180,418, filed on Feb. 4, 2000.

(51) Int. Cl. G09B 11/00

(52) U.S. Cl. 434/85

(57) ABSTRACT

A method and a system for teaching drawing skills to an individual is disclosed. The system provides sequential instructions to an individual on how to draw various figures on a touch-sensitive screen. A processor executes instructions to display a portion or an outline of a guide figure, and the individual completes the portion of the figure on the touch-sensitive screen. The system continues prompting the individual until a complete figure is entered on the touch-sensitive screen.

### CROSS REFERENCE TO RELATED APPLICATION

The present application claims the benefit of United States Provisional Application No 60/180,418 filed Feb. 4, 2000.

### FIELD OF THE INVENTION

The present invention relates to a method apparatus for drawing electronic images.

### BACKGROUND OF THE INVENTION

Art instruction typically involves students drawing or painting figures on sheets, and an art instructor evaluates the figures produced by the students on the sheets. Typically, such instruction is performed with a group of students and a single instructor in a classroom. Under such classroom conditions, the instructor normally does not have sufficient time to evaluate the work of each student individually.

Another method of art instruction is described in U.S. Pat. No. 5,252,073. According to U.S. Pat. No. 5,252,073, images are provided on a television screen, and a student duplicates the images by placing a sheet of clear or translucent material and tracing or painting the image beneath the sheet. This patent also discloses that instructional information can be provided in a section of the television screen.

While the methods described above have certain advantages, they also possess several shortcomings. First, the cost of paying an art instructor for lessons may be prohibitive for some prospective students. In addition, the time and inconvenience associated with scheduling a lesson and traveling to and from the lesson site are disadvantageous. Furthermore, the cost of sheets of material and art supplies such as pencils, paints, brushes and the like tend to make art instruction a somewhat expensive activity. Another limitation of current techniques is that it is difficult to save sheets of the student's work and to easily retrieve the student's past work for evaluation of the student's progress.

In view of the disadvantages in providing art instruction according to the methods discussed above, it would be desirable to provide a portable, hand-held system and method for drawing electronic images. It would be useful if the system and method also provided a more convenient and flexible way of providing art instruction. It would be advantageous if the art instruction could be provided in a format that allowed the student to learn in a variety of locations and without the need for traditional drawing sheets, pencils, paints, paintbrushes, etc. Furthermore, it would be useful if completed art projects by the student could be saved and easily retrieved for evaluation of a student's progress. A system and a method that enabled a user of the system to create animations from images drawn by the user would also be desirable.

### SUMMARY OF INVENTION

Accordingly, one aspect of the present invention generally relates to a convenient and flexible way of entering electronic images into a device including a processor, a memory and a display screen. Another aspect of the invention relates to linking the images entered by the individual to an animation module and creating animations from the figures entered by the individual. Still another aspect of the invention relates to a system and a method for providing artwork instruction to an individual. The method includes displaying at least a portion of a guide figure on a touch-sensitive screen and prompting the individual to enter a figure on said screen corresponding to said portion of said guide figure. After the individual has entered the figure on the screen, the figure is displayed on the screen. According to one aspect of the invention, the portion of the guide figure includes an outline of the portion of the figure to be drawn by the individual. According to this aspect, the outline may comprise, for example, a series of dots or points on the screen, and the student can enter a figure by connecting the dots. According to another aspect of the invention, the portion of the guide figure appears on the screen in a window separate from the figure drawn on the screen. According to this aspect, the student would reproduce the figure in the separate window by drawing the figure on the touch-sensitive screen using a stylus or other suitable drawing implement.

According to another aspect of the invention, the processor is operated to compare the guide figure with the figure drawn by the individual. In another aspect of the invention, the processor is operated to save the portion of the figure entered by the individual. The student can save a portion of an uncompleted figure and retrieve the figure for later completion. Alternatively, the student can continue entering the figure until the student draws a complete figure.

Another aspect of the invention relates to a system for teaching drawing skills to an individual. Preferably, the system utilizes a portable, hand-held device, such as a portable, hand-held computer enclosed in a casing. The device includes a processor, memory, and a touch-sensitive screen. The system further includes a program executable by the processor, and the program is operable to provide sequential instructions to the individual to enter a figure in accordance with the previously described method.

According to one aspect of the invention, the program is operable to display a variety of figures to be entered by the individual. Preferably, the figures are grouped into a plurality of subgroups or themes to facilitate selection of a figure of interest to the student.

The invention provides a method and system for entering electronic images, creating animations, and teaching individuals how to draw figures and artwork. The system is portable, thus providing the flexibility of allowing the student to use the system in a variety of locations. The system can be used for individualized and group instruction. Also, the student is capable of saving finished and unfinished lessons, facilitating evaluation of the student's progress. Additional features and advantages of the invention will be set forth in the description which follows. It is to be understood that both the foregoing general description and the following detailed description are exemplary and are intended to provide further explanation of the invention as claimed. In the drawings, it is to be understood that various elements of the drawings are not intended to be drawn to scale, but instead are sometimes purposely distorted for the purposes of illustrating the invention.

### BRIEF DESCRIPTION OF THE DRAWINGS

FIG. 1 is a block diagram of a system used for teaching drawing skills according to the present invention;

FIG. 2 is a top plan view of a device for providing artwork instruction according to one aspect of the invention;

FIG. 3 illustrates a view of an illustrative menu displayed on a display screen;

FIG. 4 is a flow diagram of operation according to an aspect of the invention;

FIG. 5 illustrates a view of an illustrative display screen;

FIG. 6 illustrates a view of an illustrative display screen;

FIG. 7 illustrates a view of an illustrative display screen;

FIG. 8 illustrates a view of an illustrative display screen;

FIG. 9 illustrates a view of an illustrative display screen;

FIG. 10 illustrates a view of an illustrative display screen;

FIG. 11 illustrates a view of an illustrative display screen;

FIG. 12 illustrates a view of an illustrative display screen;

FIG. 13 illustrates a view of an illustrative display screen; and

FIG. 14 illustrates a view of an illustrative display screen.

FIG. 15 illustrates a view of an illustrative display screen.

FIG. 16 illustrates a view of an illustrative display screen.

FIG. 17 illustrates a view of an illustrative display screen.

FIG. 18 illustrates a view of an illustrative animation scene on a display screen.

### DETAILED DESCRIPTION

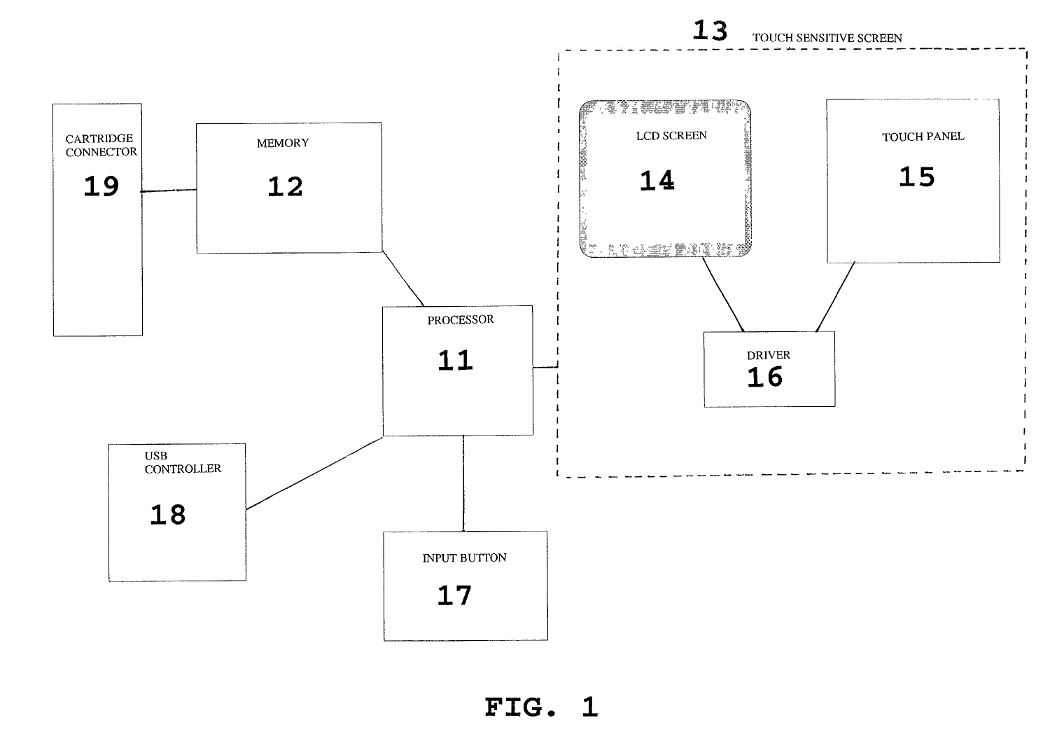

FIG. 1 shows the functional components of a system for teaching drawing skills to an individual. The system includes a processor 11, a memory 12, and a touch-sensitive display screen 13, which are in electrical communication with each other and connected in a conventional manner. The processor 11 processes the data inputted into the device and may also output data to external devices, as will be explained below. The memory 12 stores pre-selected data and files that are entered by a user of the system. The touch-sensitive screen 13 is in electrical communication with the processor 11 and the memory 12. The touch-sensitive display screen 13 preferably includes a liquid crystal display (LCD) screen 14 capable of displaying graphical information and artwork. The touch sensitive-display screen 13 also includes a touch panel 15 in electrical communication with the LCD screen 14 for accepting input from a user of the system. As will be understood by those skilled in the art, the liquid crystal display 14 and touch panel 15 will be in communication with a driver 16 according to known methods.

The system may further include at least one input button 17 in electrical communication with the processor 11 for entering commands by the user that will be executed by the processor 11. The system may also further include a universal serial bus controller 18 in electrical communication with the processor 11. The universal serial bus (USB) controller 18 may be used for establishing serial communication with a computing device or a peripheral device such as a printer, auxiliary display, scanner, etc. Accordingly, the device would include a USB connector port (not shown). Another optional feature of the system includes an external cartridge connector 19 in electrical communication with the processor 11. The external cartridge connector 18 may be utilized for connecting a flash memory card or plug and play type of cartridge. A flash memory card may be used for increasing the memory storage capacity of the system and saving data inputted by the user of the device. Plug and play cartridges enable the user of the system to input additional and updated art lessons and a variety of other media content as will be described further below.

According to one aspect of the invention, the system is implemented as a software program on a hand-held computing device or handheld computer such as a Palm®, Handspring®, or Newton® hand-held computer. However, according to a preferred aspect of the invention, the system need not be part of a hand-held computing device. Instead, to provide an inexpensive, yet functional artwork instruction device, the system minimally includes the processor 11, the memory 12, the touch-sensitive display screen 13, the touch panel 14 and the driver 15. The memory 12 and the processor 11 should be sufficient to execute sequential instructions to a user of the system to enter portions of a figure until a complete figure is drawn by the individual.

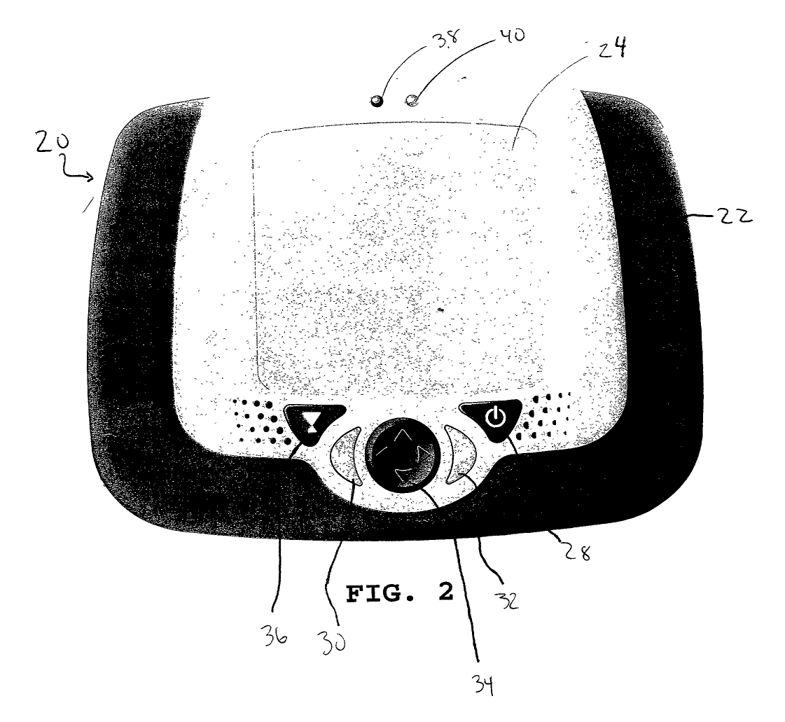

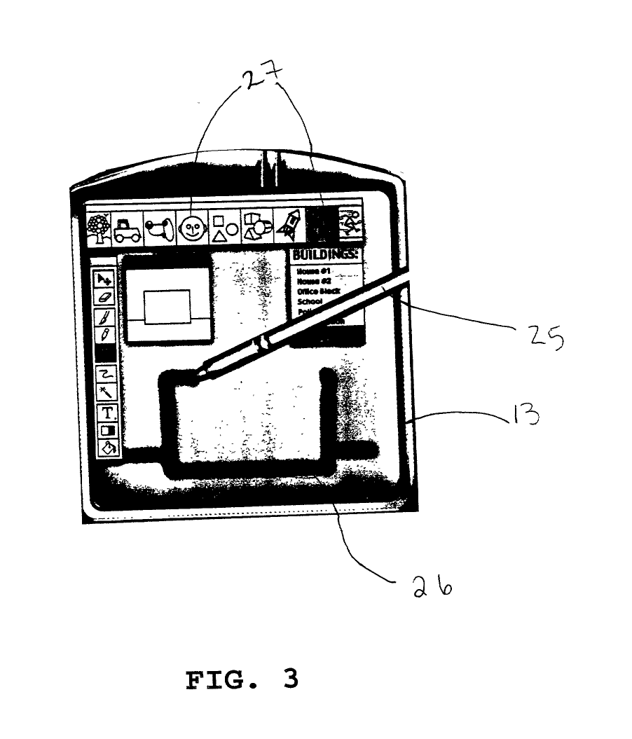

Preferably, the system is associated with a dedicated, portable, hand-held device 20, as shown in FIG. 2. The device 20 includes a casing 22 and a display 24. At least a portion of the display is a touch-sensitive display, such as the type used in personal and handheld computers. FIG. 3 shows a stylus 25 which can be used to enter a FIG. 26 on the surface of the display screen 13 or select various menu options 27 as will be described further below.

The device 20 may further include other features such as various function buttons 28, 30, 32, 34 and 36 in electrical communication with the processor 11. These buttons may include, for example, an on/off button 28, control buttons 30 and 32 for confirming the selection of icons or menu items on the display screen, a reset button 34 for resetting the memory of the device, and a navigation button 34 which allows the individual using the device to scroll through menu options, as will be described in more detail below. The device 28 may also have indicator lights 38 and 40 in electrical communication with the processor 11, which may be used, for example, to indicate whether power to the device is on or off. Other optional features of the device 20 may include a sound system, which may include speakers 42 or a headphone input (not shown) and the aforementioned universal serial bus (USB) port. The USB port may be useful for connecting the device to a computer, which in turn can be connected to the Internet for downloading updated software programs for teaching artwork and additional figures and art lessons. The device may also include a port for receiving flash memory cards, which may also be used for providing updated software programs and media and for storing artwork. The device can be powered by either batteries or alternating current through the use of an AC adapter.

In use, an individual operates the portable, hand-held drawing instruction device as shown in FIG. 3, by entering data via the touch-sensitive screen 13 or the input buttons on the device. Various commands may be activated by touching icons 27 displayed on and around the screen 13 with the stylus 25 or other suitable implement for interacting with the touch-sensitive screen. Each icon selected opens a window, which preferably remains open until a further selection is made, or until the touch-sensitive screen is touched again, providing further options available within the selected category. Confirmation of an operation may be achieved by pressing the external command button on the unit or selecting an appropriate option from the touch-sensitive screen. A FIG. 26 may be entered by selecting from a variety of simulated drawing tools selected from a menu and using the stylus to enter the figure on the touch sensitive screen. Such simulated drawing tools can include, but are not limited to, a pencil, a paintbrush, a spray paint can, an eraser, or other suitable tool for creating artwork.

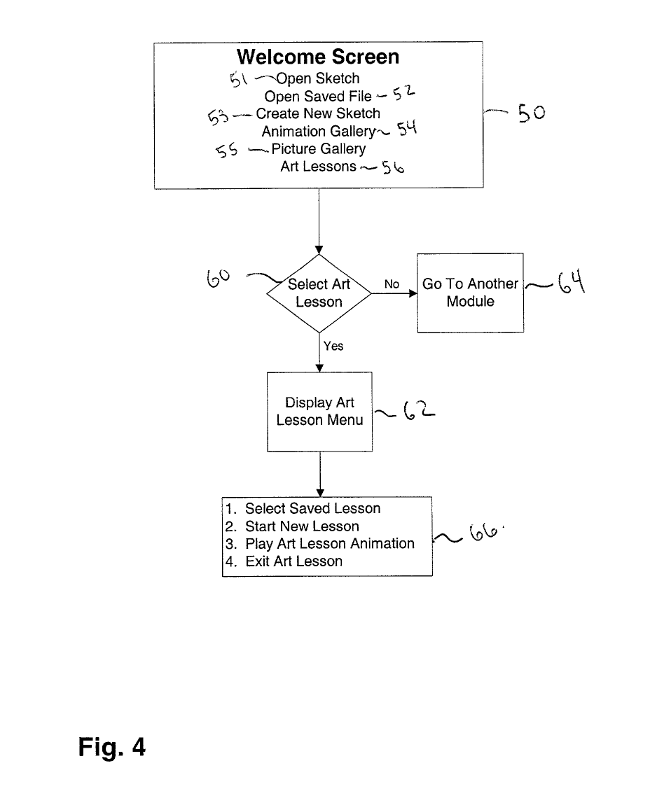

Referring now to FIG. 4, which is a flow chart illustrating the general operation of the system, upon turning on the device shown in FIG. 2, a welcome screen 50 appears in which a number of options are presented to the individual operating the device. For example, the user may be prompted to select from a variety of options, including but not limited to, opening a sketch 51 for freehand drawing, opening a previously saved file 52, creating a new freehand sketch 53, selecting an animation gallery 54, selecting a picture gallery 55, or selecting art lessons 56.

According to one aspect of the invention, the individual using the device selects one of the options as shown in block 60. If the user does not select the art lesson option 56 and selects another option as shown in block 64, the processor will execute instructions to go to another option or module. If the user does select the art lesson option the program will execute instructions to display the art lesson menu as shown in block 62.

After the individual has selected the art lesson option, the individual will be prompted to select from a variety of options shown in block 66. These options include, but are not limited to, selecting a saved lesson, starting a new lesson, playing an art lesson animation or exiting the art lesson. Selection can be made through a graphical user interface menu or other menu selection interface known in the art.

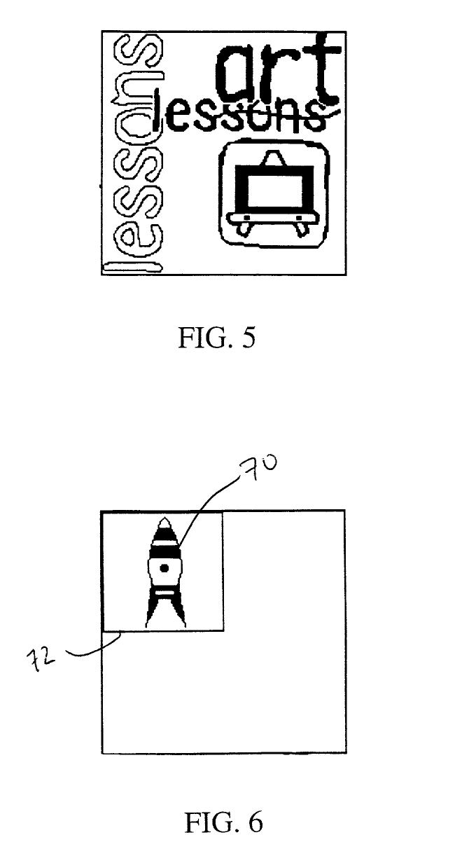

The individual using the device can start a new art lesson by selecting the appropriate menu item from the art lesson welcome screen. After the individual has selected the start new lesson menu item, the processor will execute instructions to begin an art lesson. By way of example, the processor may execute instructions to display on the screen of the device that the device is entering the art lesson mode, as shown in FIG. 5.

After entering the art lesson mode, the device may automatically begin an art lesson in which the individual using the device will be stepwise instructed to draw a figure automatically selected by the computer. By way of example and referring to FIG. 6, the processor 11 executes instructions to display a rocket 70 in a window 72 of the display screen 13. Alternatively, the processor 11 may execute instructions to display a gallery of figures for the individual to select from which may be displayed as thumbnail icons on the display screen 13. The gallery of figures may be arranged thematically, for example, a gallery including houses, birds, animals, fish, action figures, etc. The individual may then select a type of figure to be drawn and the processor 11 may execute further instructions to display a subset of figures within a particular gallery. The individual operating the device would then select a particular figure, which would then be the subject of the art lesson.

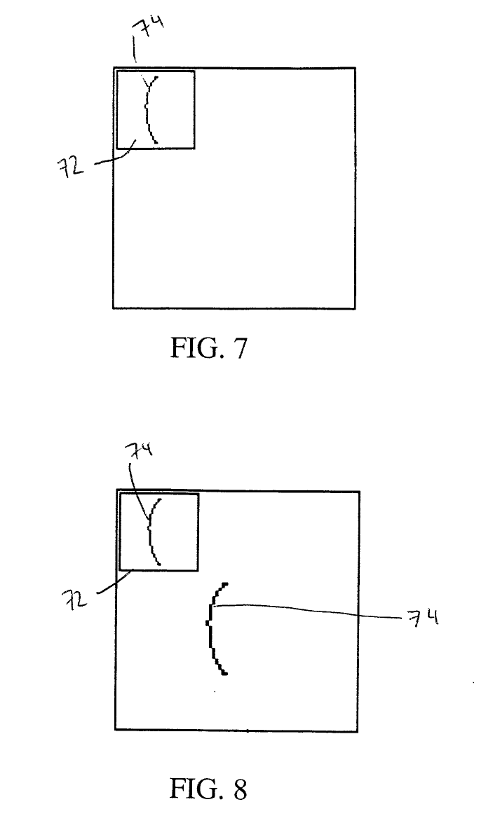

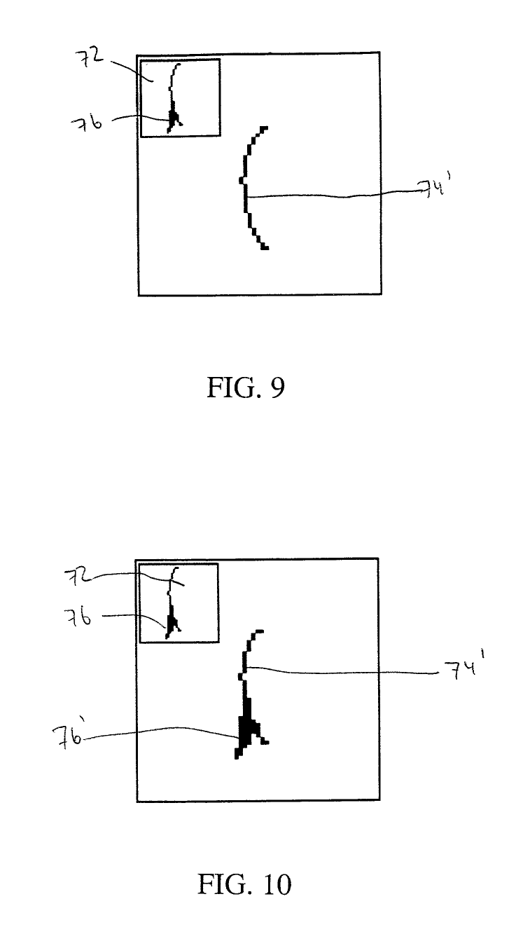

After the individual has selected a figure to draw or the computer has automatically selected and displayed a figure, the processor will execute stepwise instructions for the individual to complete the figure. According to one aspect of the invention, a first portion 74 of a figure will be displayed in window 72, as shown in FIG. 7. The individual using the device will then duplicate the first portion of the FIG. 74′ on the touch-sensitive screen 13, preferably by using the stylus 25. After the student has completed entering the first portion of the figure, the processor 11 of the system will execute instructions to display a second portion of the FIG. 76 in window 72. The individual will then enter the second portion of the FIG. 76′ on the main portion of the touch sensitive screen.

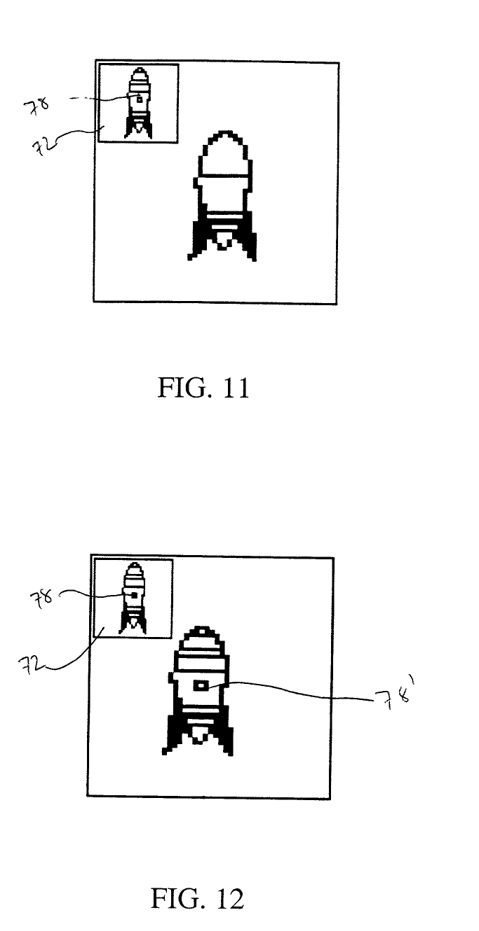

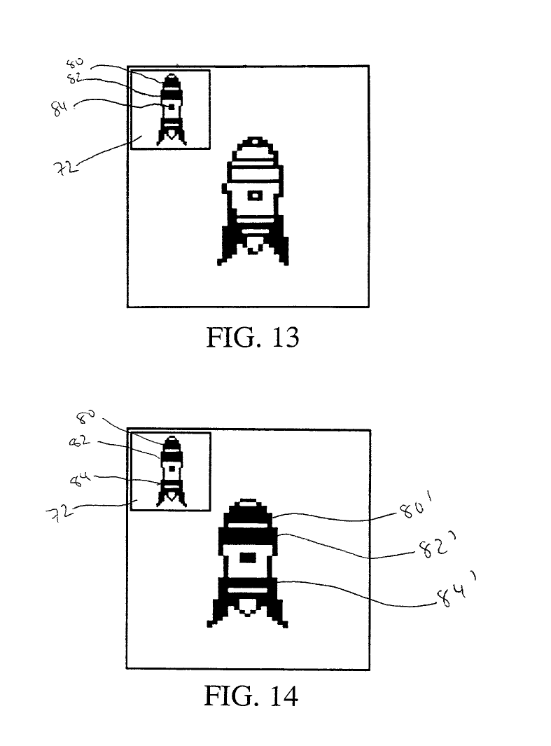

The art lesson will continue as shown in FIGS. 11-14 until the individual has drawn a complete figure. As shown in FIG. 11, portion 78 of the figure is displayed in window 72. In FIG. 12, the individual enters portion 78′ on the touch sensitive screen corresponding to the portion 78 shown in window 72. In FIG. 13, portions 80, 82 and 84 are displayed in window 72, and the individual then enters the corresponding portions 80′, 82′ and 84′ as shown in FIG. 14. After the individual has completed entry of the entire figure, the processor 11 will execute instructions to display a save function so that the student can save the artwork for future reference. The artwork can be saved to the memory 12 that is part of the device or to a memory card that can be inserted into the device (not shown). Thereafter, the student can begin a new lesson, or exit the art lesson module of the device. According to another aspect of the invention, the user of the system can save a partially drawn figure, and be provided with the option of returning to that figure to complete the lesson at another time.

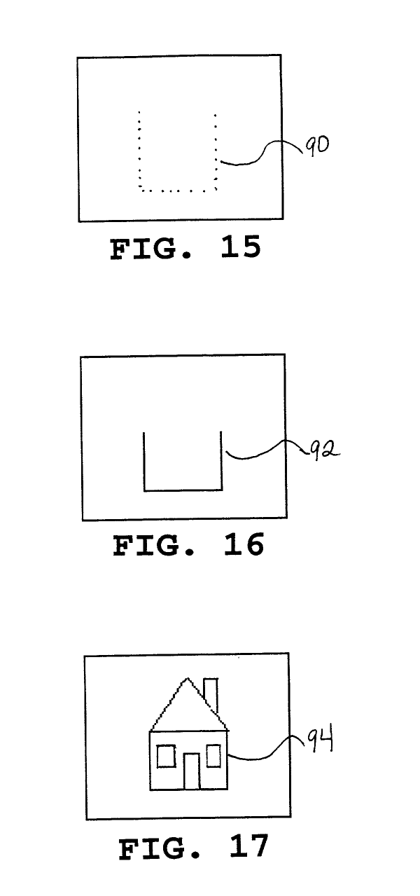

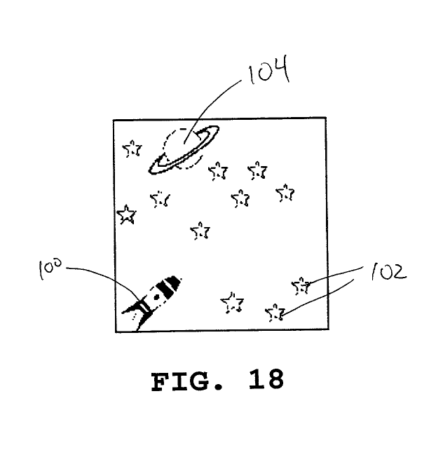

According to another aspect of the invention, the processor 11 of the system may also execute instructions to display an outline of a portion of the figure on the touch-sensitive screen. For example, as shown in FIG. 15, a series of dots or points 90 may appear on the touch-sensitive portion of the screen representing a portion of a figure to be drawn by the individual. Referring to FIG. 16, the processor 11 would execute instruction to prompt the individual to connect the dots or points 90 until the portion 92 of the figure is drawn. The processor would continue to execute stepwise instructions until a complete FIG. 94 is drawn by the individual, as shown in FIG. 17, which depicts a house.

According to another aspect of the invention, after the individual completes a sketch in the art lesson, the user may be prompted to save the sketch as a new sketch, or alternatively, the user may be able to create an animation from the completed sketch. For example, after the individual completes the sketch shown in FIG. 13, which is a rocket, the user of the system may be prompted to save the rocket as an animation, which may be selected from a menu of options. If the user selects the option to save the drawing as an animation, an animation sequence will be started by the processor and displayed on the display screen. For example, referring to FIG. 18, if the user completes a drawing of a rocket as shown in FIG. 13 and selects the option to save the rocket as an animation, the system would display a rocket 100 in animation scene with stars 102 and a planet 104 displayed together with the rocket 100.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

What is claimed is:

1. A method of instructing an individual to draw a figure comprising:
a. displaying at least a portion of a guide figure on a touch-sensitive screen, said screen electrically connected to a processor and an memory;
b. prompting the individual to enter at least a portion of said figure on said screen corresponding to said portion of said guide figure;
c. displaying said figure on said screen entered by the individual; and
d. repeating steps (a) through (c) until said figure is drawn by said individual.

2. The method of claim 1, wherein the portion of the guide figure comprises an outline of the portion of the figure to be drawn by the individual.

3. The method of claim 2, wherein the outline of the portion of the figure to be drawn includes a series of points to be connected by the individual on the screen.

4. The method of claim 1, wherein the portion of the guide figure appears on the screen in a window separate from the figure drawn on the screen.

5. The method of claim 1, further comprising the step of operating the processor to compare the guide figure with the figure drawn by the individual.

6. The method of claim 1, wherein entering the figure on the screen includes drawing the figure on the touch-sensitive screen.

7. The method of claim 6, wherein the individual draws the figure using a stylus.

8. The method of claim 5, further comprising the step of operating the processor to save the portion of the figure entered by the individual.

9. The method of claim 8, further comprising the step of operating the processor to create an animation including the figure drawn by the individual.

10. The method of claim 1, wherein the processor, the screen and the memory are included in a portable, hand-held device.

11. A system for teaching drawing skills to an individual comprising:
a processor, memory, a touch-sensitive screen, and a processor; and
a program executable by said processor, said program operable to provide sequential instructions to the individual to enter a figure, the sequential instructions including the steps of displaying at least a portion of a guide figure on the touch-sensitive screen, prompting the individual to enter at least a portion of said figure on said screen corresponding to said portion of said guide figure, and displaying the figure entered by the individual on the screen.

12. The system of claim 11, wherein the program is operable to repeat the steps of the sequential instructions until a complete figure has been entered by the individual.

13. The system of claim 12, wherein the touch sensitive screen, the processor and the memory are part of a hand-held device contained in a casing.

14. The system of claim 12, wherein the program is operable to display a variety of figures to be entered by the individual wherein the figures are grouped into a plurality of subgroups.

15. The system of claim 12, wherein the portion of the guide figure comprises and outline of the portion to of the figure to be entered by the individual.

16. The system of claim 15, wherein the outline of the portion of the figure to be entered by the individual includes a series of points to be connected by the individual on the screen.

17. The system of claim 12, wherein the portion of the guide figure appears on the screen in a window separate from the figure entered on the screen by the individual.

18. The system of claim 12, wherein the program is operable to compare the guide figure with the figure drawn by the individual.

19. The system of claim 18, wherein the program is operable to provide the option to enable the individual to create an animation from the entered figure.

20. The system of claim 11, wherein the system further includes a stylus for the individual to draw figures on the touch-sensitive screen.
